(19) United States
(12) Patent Application Publication
(10) Pub. No.: US 2022/0152709 A1
(43) Pub. Date: May 19, 2022

(54) HYDRAULIC EXPANSION CHUCK

(71) Applicant: Guehring KG, Albstadt (DE)

(72) Inventors: Simon HERZOG, Bad Saulgau (DE); Christian STEIDLE, Albstadt (DE); Andreas LOEW, Hohentengen (DE); Martin GUTMACHER, Sigmaringen (DE)

(73) Assignee: Guehring KG, Albstadt (DE)

(21) Appl. No.: 17/645,804

(22) Filed: Dec. 23, 2021

Related U.S. Application Data
(63) Continuation of application No. PCT/EP2020/066555, filed on Jun. 16, 2020.

(30) Foreign Application Priority Data
Jul. 2, 2019 (DE) 10 2019 209 684.0

(51) Int. Cl. B23B 31/117; B23B 31/00; B23B 31/30

(52) U.S. Cl. CPC B23B 31/1178; B23B 31/305; B23B 31/005

(57) ABSTRACT

The invention relates to a hydraulic expansion chuck comprising a main body (1) that extends along a rotational or longitudinal central axis (2) and is composed of a shaft part (20), for directly or indirectly coupling the hydraulic expansion chuck to a module of a modular tool system or to a machine spindle, and a clamping part (30), joined to the shaft part in a rotationally and axially fixed manner for receiving and clamping a shank tool. The shaft part comprises a receiving socket which extends towards the clamping part and has a central socket-opening in which a connection pin (31) of the clamping part, which pin extends towards the shaft part, is form-fittingly received. According to the invention, the clamping part comprises a stop which is radially offset from the connection pin and axially strikes the receiving socket.

The invention relates to a hydraulic expansion chuck according to the preamble of claim 1.

A hydraulic expansion chuck of this type is known, for example, from WO 2017/093280 A1 and has a base body, which extends along a rotational or longitudinal central axis and which can be functionally divided into a clamping part (referred to as expansion bushing in WO 2017/093280 A1) for receiving and clamping a shaft tool and a shaft part (referred to as base body in WO 2017/093280 A1) for directly or indirectly coupling the hydraulic expansion chuck to a module of a modular tool system or to a machine spindle.

Around a central receiving opening, the clamping part has two pressure chambers, to which fluid pressure can be applied and which are each separated from the receiving opening via an elastically resilient expansion wall and which are connected via a pressure duct to a pressure generating means arranged in the base body. The expansion walls bulge against a shaft tool, e.g. drill or milling tool, which is received in the central receiving opening, during a fluid pressure application of the pressure chambers, in order to clamp the shaft tool, which is received in the central receiving opening, in a non-positive manner.

The shaft part has a receiving sleeve (referred to as clamping part in WO 2017/093280 A1), which extends towards the clamping part and which receives a connecting pin-like longitudinal portion of the clamping part, which extends towards the shaft part. The axial position of the clamping part is adjustably defined by means of an axial stop, which is provided in the shaft part and which is formed from a sleeve-shaped screw element and a sleeve-shaped elastic support element, against which the clamping part is axially supported. The insertion depth of the clamping part in the shaft part and thus the axial length of the hydraulic expansion cuck is thus determined by means of the screw-in depth of the screw element in the shaft part, so that attention must be paid to a correct position of the screw element in the shaft part during the assembly of the hydraulic expansion chuck. The axial position of a shaft tool clamped in the clamping part, in turn, is adjustably defined by means of an adjusting screw, which is screwed into the clamping part.

Based on the hydraulic expansion chuck specified in WO 2017/093280 A1, the present invention is based on the object of providing a hydraulic expansion chuck, which is assembled from a separately produced clamping and shaft part and which provides for a fastening, which is positionally accurate in the radial and axial direction, of the clamping part to the shaft part, and which can thus be produced more easily.

This object is solved by means of a hydraulic expansion chuck comprising the features of claim 1. Advantageous or preferred further developments are subject matter of dependent claims.

A hydraulic expansion chuck according to the invention comprises a base body, which extends along a rotational or longitudinal central axis and which is comprised of a shaft part for the direct or indirect coupling of the hydraulic expansion chuck to a module of a modular tool system or to a machine spindle, and a clamping part, which is joined to the shaft part in a rotationally and axially fixed manner, for receiving and clamping a shaft tool, e.g. drill or milling tool. The shaft part has a receiving sleeve extending towards the clamping part comprising a central sleeve opening, in which a connecting pin of the clamping part, which extends towards the shaft part, is received. The radial position of the clamping part on the shaft part is thus defined via the connecting pin, which is received in the receiving sleeve. For this purpose, the connecting pin can be received in a positive manner in the receiving sleeve with a defined radial play.

In contrast to the above-discussed generic hydraulic expansion chucks, the clamping part has, according to the invention, a stop, which is radially offset from the connecting pin and which axially strikes against the receiving sleeve. The radially offset stop ensures an axial securing, which can be attained easily and which is defined unambiguously, of the clamping part to the shaft part. Due to the radial offset of the stop from the connecting pin, an axial support of the clamping part on the shaft part is furthermore attained, which lies at a larger radial distance from the rotational or longitudinal central axis of the hydraulic expansion chuck than in the case of the hydraulic expansion chuck discussed above, whereby a vibration-optimized, stable connection between clamping part and shaft part is attained.

For this purpose, the clamping part-side stop and the receiving sleeve are designed so that a flat abutment of the stop against the receiving sleeve results. The stop can have, for example, a ring-shaped or ring segment-shaped, thus, e.g., a circular ring-shaped, circular ring segment-shaped, truncated cone-shaped or truncated cone segment-shaped, stop surface, which faces the shaft part and which abuts in an accurately fitting manner against the receiving sleeve, on a front-side counter surface facing the clamping part. The stop surface can in particular be a circular ring surface or truncated cone surface, which encases the connecting pin and which is continuous or discontinuous in the circumferential direction. The counter surface at the receiving sleeve can be formed according to the stop surface at the clamping part.

To obtain a connection, which is permanently fixed in the direction of rotation and axial direction, the clamping part can be connected in a non-positive manner and/or by means of a substance-to-substance bond, in particular screw-connected and/or welded, to the shaft part.

For this purpose, the connecting pin can have a guide portion, which can be axially inserted in a radially positive manner into a receiving portion of the sleeve opening. The connecting pin can additionally have an externally threaded portion, which can be axially screwed into an internally threaded portion of the receiving sleeve. The guide portion has the function of axially guiding the connecting pin, which is inserted into the receiving sleeve, in terms of a simple assembly of clamping part and shaft part. For this purpose, the guide portion and the receiving portion can be formed cylindrically, preferably circular cylindrically, or so as to be (slightly) tapered conically towards the shaft part. The guide portion is preferably received in the receiving portion of the sleeve opening with a (narrowly) defined play adaptation. In the case of conical guide portions, the external cone and internal cone are dimensioned and tolerated so that the axial abutment, which is desired according to the invention, of the clamping part-side contact surface against the shaft part-side stop surface is always ensured. Additionally or alternatively to the guide portion, the above-mentioned externally threaded portion ensures an axial tensioning between clamping part and shaft part. The clamping part can furthermore be welded to the shaft part in the contact region of the clamping part-side stop and the receiving sleeve.

In terms of a weight and unbalance reduction, the receiving sleeve can have a reduced diameter compared to a longitudinal portion of the shaft part facing away from the clamping part. For example, the receiving sleeve can conically taper from the longitudinal portion of the shaft part, which faces away from the clamping part, towards the clamping part. The clamping part can furthermore connect in a radially flush manner to the receiving sleeve.

The clamping part of the hydraulic expansion chuck has at least one pressure chamber, to which fluid pressure can be applied and which can be connected in a manner known per se to a pressure source via a pressure duct, and to a ventilation means via a ventilation duct. The pressure source and/or ventilation means are/is advantageously arranged in the shaft part, whereby the radial expansion and thus the weight of the clamping part, which is susceptible to vibrations, can be kept low. An unbalance caused by an uneven mass distribution can furthermore be kept low. Taking this idea into account, the ventilation duct and the pressure duct can furthermore lie offset to one another by essentially 180° with respect to the rotational or longitudinal central axis.

The pressure duct can lead over a joining gap, which corresponds to an axial play, between a front surface of the connecting pin facing the shaft part, and a base surface of the sleeve opening, which faces the clamping part, in the receiving sleeve, wherein the pressure duct is preferably sealed in the region of this joining gap. This sealing can take place by means of a pair of annular seals, which can be arranged in the receiving sleeve between the front surface of the connecting pin facing the shaft part and the base surface of the sleeve opening facing the clamping part. In the alternative, one of the annular seals can be arranged in the receiving sleeve between the front surface of the connecting pin facing the shaft part and the base surface of the sleeve opening facing the clamping part, and the other annular seal can be arranged in the receiving sleeve between a jacket surface of the connecting pin and an inner surface of the sleeve opening. In the above-specified first case, the annular seals can be formed as annular seals made of copper or can be formed from another suitable material, e.g. metal or plastic. In the above-mentioned second case, the annular seals can be formed as O-rings made of rubber or another elastic material.

The shaft part and/or the clamping part of the hydraulic expansion chuck can be made monolithically, in particular additively. 3D printing processes for the additive manufacture have meanwhile established themselves in the field of the tool technology and allow for a simple production of complex hollow structures, such as of the at least one pressure chamber, the pressure duct, or the ventilation duct.

The hydraulic expansion chuck can furthermore have a central opening axially passing through the shaft part and the clamping part, via which, for example, a shaft tool clamped in the clamping part can be supplied with a cooling lubricant fluid. For this purpose, the shaft part of the hydraulic expansion chuck preferably has a hollow shaft, to which the central opening, which passes through, connects. The hollow shaft is preferably formed as a hollow shaft taper (HSK), which is known to the person of skill in the art, but it can also be formed, e.g., as steep taper (SK) or cylinder shaft.

An axial stop, e.g. an adjusting screw, for a shaft tool received in the clamping part can further be arranged in the clamping part of the hydraulic expansion chuck. The above-mentioned central opening can lead through the axial stop. The axial stop can be adjustable for adapting the receiving depth of the shaft tool in the clamping part.

The present invention will be described below on the basis of enclosed drawings.

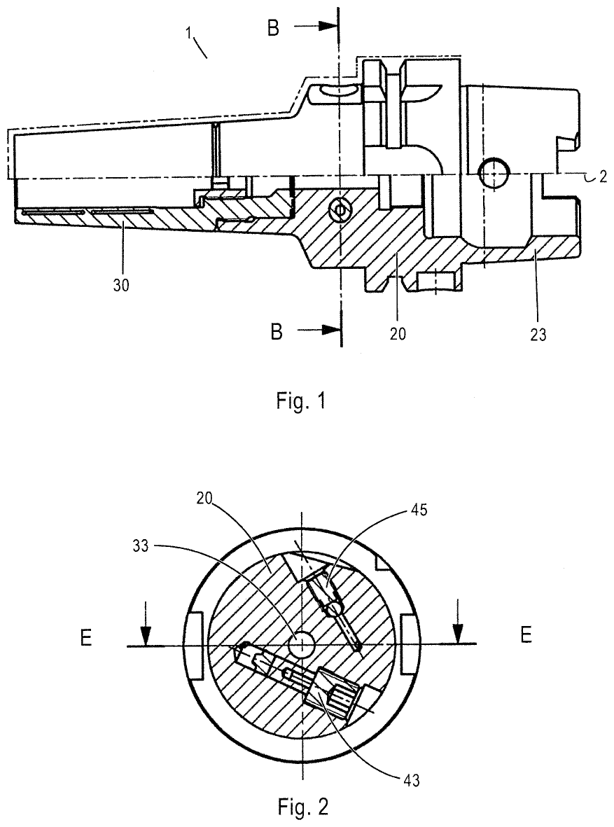

FIG. 1 shows a half section of a hydraulic expansion chuck according to the invention according to a first embodiment along a rotational or longitudinal central axis.

FIG. 2 shows a section of a hydraulic expansion chuck according to the invention according to the first embodiment transversely to the rotational or longitudinal central axis at a point, which is specified with B-B in FIG. 1.

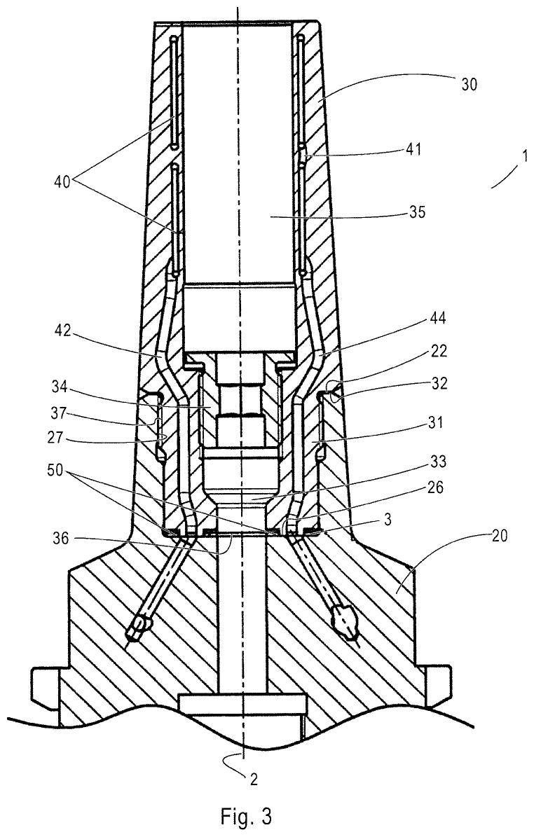

FIG. 3 shows a partial section of the hydraulic expansion chuck according to the invention according to the first embodiment along the rotational or longitudinal central axis in a plane, which is specified with E-E in FIG. 2.

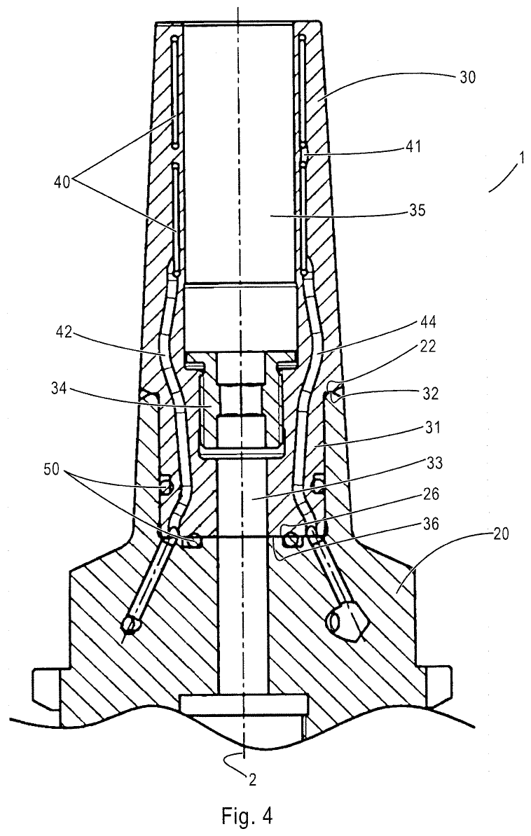

FIG. 4 shows a partial section of a hydraulic expansion chuck according to the invention according to a second embodiment along the rotational or longitudinal central axis in a plane, which is specified with E-E in FIG. 2.

FIGS. 1 to 3 show a first embodiment of a hydraulic expansion chuck according to the invention.

The hydraulic expansion chuck according to the invention comprises a base body 1, which extends along a rotational or longitudinal central axis 2. The base body 1 is comprised of a shaft part 20 and a clamping part 30, which is axially attached to the shaft part 20.

The shaft part 20 is provided to connect the base body 1 on the side facing away from the clamping part 30 to a (non-illustrated) module of a modular tool system or of a (non-illustrated) machine spindle.

As is shown in FIG. 1, the shaft part 20 has, for this purpose, a hollow shaft 23 on the side facing away from the clamping part 30. In the shown embodiment, the hollow shaft 23 is formed by a HSK shaft, which is known per se to the person of skill in the art.

On the side facing the clamping part 30, the shaft part has a receiving sleeve 21 extending along the rotational or longitudinal central axis 2 towards the clamping part 30 comprising a central sleeve opening, as is shown in FIG. 3. FIG. 3 shows that the receiving sleeve 21, i.e. the upper longitudinal portion of the shaft part in FIG. 3, slightly tapers conically towards the clamping part 30 and that the diameter thereof is consistently smaller than the lower longitudinal portion of the shaft part in FIG. 3.

The front side of the receiving sleeve 21 located on the top in FIG. 3 forms a counter surface 22, against which a stop surface 32, which is provided at the clamping part 30, abuts in an axially flush manner. In the first embodiment, the counter surface 22 is formed in a circular ring-shaped manner and lies in a cross sectional plane of the base body 1.

The sleeve opening can be divided axially into an inner receiving portion, which is formed in a circular cylindrical manner in the shown first embodiment, and an outer internally threaded portion 27.

The clamping part 30 is provided for receiving and hydraulically clamping a (non-illustrated) shaft tool, such as, for instance, a drill or milling tool, in a central receiving opening 35. On the side facing the shaft part 20, the clamping part 30 has a connecting pin 31, which extends towards the shaft part 20 and which is received in an accurately fitting manner in the receiving sleeve 21. For this purpose, the connecting pin 31 has, corresponding to the sleeve opening, a cylindrical guide portion, which sits in a radially positive manner in the receiving portion of the sleeve opening, as well as an externally treaded portion 37, which is screwed into the internally threaded portion 27. As shown in FIG. 3, the externally threaded portion 37 of the clamping part 30 is screwed into the internally threaded portion 27 of the receiving sleeve 21 so deeply that the clamping part 30 strikes against the above-mentioned shaft part-side counter surface 22 with a front-side stop surface 32 facing the shaft part and encasing the connecting pin 31. The stop surface 32, which is formed in a circular ring-shaped manner in the first embodiment, forms a stop according to the claim, which limits the insertion depth of the clamping part 30 in the shaft part 20 and thus defines the axial position of the clamping part 30 at the shaft part 20 and the axial total length of the base body 1 or hydraulic expansion chuck, respectively.

FIG. 3 shows that the clamping part 30 connects in a radially flush manner to the receiving sleeve 21, and how the receiving sleeve 21 is slightly tapered conically. FIG. 3 furthermore shows that the clamping part 30 is additionally connected by means of a substance-to-substance bond by means of welding to the shaft part 20 in the contact region of the clamping part-side stop surface 32 and the shaft part-side counter surface 22. In the joining state shown in FIG. 3, the connecting pin 31 extends so far into the receiving sleeve 21 that a front surface 36 of the connecting pin 31 facing the shaft part 20 is spaced apart from a base surface 26 of the sleeve opening facing the clamping part 30 by a narrowly designed axial play or a narrowly dimensioned joining gap 3. The narrowly dimensioned joining gap 3 ensures the axial abutment of the stop surface 32, which encases the connecting pin 31, against the clamping part 30 at the counter surface 22, which encases the sleeve opening, of the receiving sleeve 21 of the shaft part. The axial length of the connecting pin 31 is therefore smaller than the depth of the sleeve opening of the receiving sleeve 21 by the axial play.

FIG. 3 furthermore shows a central opening 33, which axially passes through the clamping part 30 and shaft part 20. This central opening 33 connects a hollow space of the hollow shaft 23 to the central receiving opening 35 in the clamping part 30, and serves for the supply of a shaft tool, which is clamped in the clamping part 30, with a cooling lubricant fluid. To set the receiving depth of the shaft tool, the clamping part 30 furthermore has an axial stop, which is formed by an adjusting screw 34. The central opening 33 leads through the adjusting screw 34.

Around the central receiving opening 35, the clamping part 30 has two pressure chambers 40, to which fluid pressure can be applied, in the shown embodiment. The two pressure chambers 40 are connected to one another via an eccentrically located connecting duct 41. A pressure duct 42 and a ventilation duct 44 in each case lead into the pressure chamber 40, which is located closer to the shaft part 20, wherein they run towards a pressure source 43 or a ventilation means 45, respectively, which are shown in FIG. 2, in the direction of the rotational or central longitudinal axis 2 as well as eccentrically to the central opening 33. The pressure duct 42 and the ventilation duct 44 are offset to one another by essentially 180° with respect to the rotational or longitudinal central axis 2.

As shown in FIG. 2, the portion of the pressure duct 42, which is arranged in the shaft part 20, is connected to a pressure source 43, which is arranged in the shaft part 20, and the portion of the ventilation duct 44, which is arranged in the shaft part 20, is connected to a ventilation means 45, which is arranged in the shaft part 20.

In the embodiment shown in FIG. 3, the pressure duct 42 and the ventilation duct 44 are sealed at the transition between the front surface 36 and the base surface 26, i.e. in the region of the joining gap 3, by means of a pair of annular seals 50.

In the first embodiment shown in FIG. 3, two copper sealing rings are arranged between the front surface 36 and the base surface 26, which are in each arranged around the openings of the pressure duct 42 and ventilation duct 44 between the front surface 36 and the base surface 26, and which are pressed between the two surfaces. The required pressing pressure is attained by means of the screw-connection of the clamping part 30 with the shaft part 20.

As can be seen from the different shadings in FIG. 3, the shaft part 20 and the clamping part 30 were initially fabricated separately from one another and were joined subsequently in the shown embodiment. The clamping part 30, which, with the two pressure chambers 40, the pressure duct 42, the ventilation duct 44, etc., has more complex hollow structures, can be fabricated additively, e.g., by means of a 3D printing process. The shaft part 20 can likewise be manufactured additively, but for economical reasons, it can also be fabricated in a conventional manner by means of machining of a metallic body, because, with the portions of the pressure duct 42 and ventilation duct 44, which are essentially linear here, the receiving sleeve 21, the hollow shaft 23, etc., it has hollow structures, which can be realized more easily. FIG. 4 shows a second embodiment of a hydraulic expansion chuck according to the invention, which only differs from the first embodiment in the manner of the sealing of the pressure and ventilation duct 44, which leads over the joining gap 3.

In the case of the second embodiment shown in FIG. 4, two O-rings made of rubber are provided instead of the two copper sealing rings as annular seals 50. One of the two O-rings is thereby arranged radially within the openings of the pressure duct 42 and ventilation duct 44 between the front surface 36 and the base surface 26, and the other one of the two O-rings is arranged between the jacket surface of the guide portion of the connecting pin 31 and the inner surface of the receiving portion of the receiving sleeve 21. In the second embodiment, the clamping part 30 is furthermore not screw-connected to the shaft part 20. The connecting pin 31 is thus only formed from one guide portion, while the sleeve opening of the receiving part is only formed from one receiving portion. To ensure a rotationally and axially fixed fastening of shaft part 20 and clamping part 30, a substance-to-substance bond by means of, e.g., welding, soldering, or the like, of the counter surface 22 and stop surface 32, which touch one another, is thus required.

Deviations from the above-described embodiments are possible within the scope of protection of the claims.

In addition to a screw-connection by means of threaded portions, which are formed integrally with the shaft part 20 or clamping part 30, respectively, the rotationally and axially fixed connection of shaft part 20 and clamping part 30 can thus also take place by means of axial screw-connection with the help of several screws or the like.

Instead of the two pressure chambers 40 shown in FIGS. 3 and 4, one, three, four, or more pressure chambers 40 can furthermore be provided.

The axial length of the connecting pin 31 can furthermore be essentially identical to the axial depth of the sleeve opening, the front surface 36 of the connecting pin 31 can thus abut more or less flush against the base surface 26 of the sleeve opening. A joining gap 3 between the front surface 36 of the connecting pin 31 and the base surface 26 of the sleeve opening is thus not absolutely necessary, as long as an abutment of the clamping part-side stop against the receiving sleeve 21 of the shaft part is ensured.
1 base body
2 rotational or longitudinal central axis
3 joining gap
20 shaft part
21 receiving sleeve
22 counter surface
23 hollow shaft
26 base surface
27 internally threaded portion
30 clamping part
31 connecting pin
32 stop surface
33 central opening, which passes through
34 adjusting screw
35 receiving opening
36 front surface
37 externally threaded portion
40 pressure chambers
41 connecting duct
42 pressure duct
43 pressure source
44 ventilation duct
45 ventilation means
50 annular seals

1. A hydraulic expansion chuck comprising a base body, which extends along a rotational or longitudinal central axis and which is comprised of a shaft part for the direct or indirect coupling of the hydraulic expansion chuck to a module of a modular tool system or to a machine spindle, and a clamping part, which is joined to the shaft part in a rotationally and axially fixed manner, for receiving and clamping a shaft tool, wherein the shaft part has a receiving sleeve extending towards the clamping part comprising a central sleeve opening, in which a connecting pin of the clamping part, which extends towards the shaft part, is received in a positive manner,
the clamping part having a stop, which is radially offset with respect to the connecting pin and which axially strikes against the receiving sleeve.

2. The hydraulic expansion chuck according to claim 1, wherein the stop abuts flat against the receiving sleeve.

3. The hydraulic expansion chuck according to claim 2, wherein the stop has a ring-shaped or ring segment-shaped stop surface, which abuts against the receiving sleeve on a front-side counter surface.

4. The hydraulic expansion chuck according to claim 1, wherein the clamping part is connected in a positive manner, non-positive manner and/or by means of a substance-to-substance bond, to the shaft part.

5. The hydraulic expansion chuck according to claim 1, wherein the connecting pin has a guide portion, which can be axially inserted into the receiving sleeve.

6. The hydraulic expansion chuck according to claim 1, wherein the connecting pin has an externally threaded portion, which can be axially screwed into the receiving sleeve.

7. The hydraulic expansion chuck according to claim 1, wherein the receiving sleeve has a reduced diameter compared to a longitudinal portion of the shaft part facing away from the clamping part.

8. The hydraulic expansion chuck according to claim 1, wherein the receiving sleeve conically tapers from a longitudinal portion of the shaft part, which faces away from the clamping part, towards the clamping part.

9. The hydraulic expansion chuck according to claim 1, wherein the clamping part connects in a radially flush manner to the receiving sleeve.

10. The hydraulic expansion chuck according to claim 1, wherein the clamping part has at least one pressure chamber, to which fluid pressure can be applied and which is connected to a pressure source arranged in the shaft part via a pressure duct, and
the pressure duct leads over a joining gap, which corresponds to an axial play, between a front surface of the connecting pin facing the shaft part, and a base surface of the sleeve opening, which faces the clamping part.

11. The hydraulic expansion chuck according to claim 10, wherein the pressure duct is sealed in the region of the joining gap.

12. The hydraulic expansion chuck according to claim 11, wherein the pressure duct is sealed by means of a pair of annular seals, which are arranged between the front surface of the connecting pin and the base surface of the sleeve opening.

13. The hydraulic expansion chuck according to claim 11, wherein the pressure duct is sealed by means of a pair of annular seals, one annular seal of which is arranged between the front surface of the connecting pin and the base surface of the sleeve opening, and the other annular seal is arranged between a jacket surface of the connecting pin and an inner surface of the sleeve opening.

14. The hydraulic expansion chuck according to claim 10, wherein the chuck further comprises a ventilation duct, which connects the at least one pressure chamber to a ventilation means.

15. The hydraulic expansion chuck according to claim 14, wherein the ventilation means is arranged in the shaft part.

16. The hydraulic expansion chuck according to claim 14, wherein the ventilation duct and the pressure duct lie offset to one another by 180° with respect to the rotational or longitudinal central axis.

17. The hydraulic expansion chuck according to claim 1, wherein the shaft part and/or the clamping part are in each case made monolithically.

18. The hydraulic expansion chuck according to claim 1, wherein the chuck further comprises a central opening axially passing through the shaft part and the clamping part.

19. The hydraulic expansion chuck according to claim 1, wherein the shaft part has a hollow shaft.

20. The hydraulic expansion chuck according to claim 1, wherein an axial stop is arranged in the clamping part in particular in the form of an adjusting screw, which is screw-connected to the clamping part, for a shaft tool, which is to be received in the clamping part.

21. The hydraulic expansion chuck according to claim 4, wherein the clamping part is screw-connected and/or welded to the shaft part.

22. The hydraulic expansion chuck according to claim 17, wherein the shaft part and/or the clamping part are in each case made additively.

23. The hydraulic expansion chuck according to claim 1, wherein an axial stop is arranged in the clamping part, in the form of an adjusting screw, which is screw-connected to the clamping part, for a shaft tool, which is to be received in the clamping part.
